(19) United States
(12) Patent Application Publication
(10) Pub. No.: US 2016/0152770 A1
(43) Pub. Date: Jun. 2, 2016

(54) SEMI-AROMATIC COPOLYAMIDES HAVING HIGH GLASS TRANSITION TEMPERATURE AND HIGH DEGREE OF CRYSTALLINITY

(71) Applicant: BASF SE, Ludwigshafen (DE)

(72) Inventors: Florian Richter, Mannheim (DE); Christian Schmidt, Ludwigshafen (DE); Joachim Clauss, Darmstadt (DE); Stefan Schwiegk, Neustadt (DE); Axel Wilms, Frankenthal (DE); Gad Kory, Gaiberg (DE)

(21) Appl. No.: 14/896,773

(22) PCT Filed: Jun. 11, 2014
(86) PCT No.: PCT/EP2014/062114

§ 371 Date: Dec. 8, 2015

(30) Foreign Application Priority Data
Jun. 12, 2013 (EP) 13171659.9

(51) Int. Cl. C08G 69/26; C08L 77/06

(52) U.S. Cl. CPC C08G 69/265; C08L 77/06

(57) ABSTRACT

The present invention relates to semi-aromatic copolyamides having a high glass transition temperature and a high degree of crystallinity, to a polyamide molding compound containing said semi-aromatic copolyamide and to the use of the semi-aromatic copolyamides and of the polyamide molding compounds.

### BACKGROUND OF THE INVENTION

The present invention relates to semiaromatic copolyamides having a high glass transition temperature and high crystallinity, to a polyamide molding composition comprising such a semiaromatic copolyamide and to the use of the semiaromatic copolyamides and of the polyamide molding compositions.

### STATE OF THE ART

Polyamides are one of the polymers produced on a large scale globally and, in addition to the main fields of use in films, fibers and materials, serve for a multitude of further end uses. An important group of polyamides is that of semicrystalline or amorphous thermoplastic semiaromatic polyamides, which have found a wide range of use as important industrial plastics. They are especially notable for their high thermal stability and are also referred to as high-temperature polyamides (HTPA). An important field of use of the HTPAs is the production of electrical and electronic components, and suitable polymers for use in soldering operations under lead-free conditions (lead free soldering) are especially those based on polyphthalamide (PPA). HTPAs serve, inter alia, for production of plug connectors, microswitches and -buttons and semiconductor components, such as reflector housings of light-emitting diodes (LEDs). A further important field of use of the HTPAs is in high-temperature automotive applications. Important properties here are good heat aging resistance, and high strength and toughness and weld seam strength of the polymers used. Amorphous HTPAs or those having very low crystalline contents are transparent and are especially suitable for applications where transparency is advantageous. Semicrystalline HTPAs are generally notable for long-term stability at high ambient temperature and are suitable, for example, for applications in the engine bay area.

Polyamides for use in molding compositions for high-temperature applications have to have a complex profile of properties, it being necessary to reconcile good mechanical properties even in the event of prolonged thermal stress with good processibility. For example, high proportions of hexamethylenediamine/terephthalic acid improve crystallinity and significantly increase the glass transition temperatures, but processibility often worsens with increasing content of these monomer units because of the high melting temperatures.

WO 2008/155271 describes a process for preparing semiaromatic copolyamide based on dicarboxylic acids and diamines, where the monomer mixture is composed of 50 mol % of dicarboxylic acid mixture (60 to 88% by weight of terephthalic acid and 40% by weight of isophthalic acid) and 50 mol % of hexamethylenediamine. It is stated in quite general terms that 0 to 5% by weight of the hexamethylenediamine may be replaced by other C₂₋₃₀ diamines.

EP 0 667 367 A2 describes semiaromatic semicrystalline thermoplastic polyamide molding compositions comprising

A) 40 to 100% by weight of a copolyamide formed from
a1) 30 to 44 mol % of units which derive from terephthalic acid,
a2) 6 to 20 mol % of units which derive from isophthalic acid,
a3) 43 to 49.5 mol % of units which derive from hexamethylenediamine,
a4) 0.5 to 7 mol % of units which derive from aliphatic cyclic diamines having 6 to 30 carbon atoms,

where the molar percentages of components al) to a4) together add up to 100% and

B) 0 to 50% by weight of a fibrous or particulate filler,

C) 0 to 30% by weight of an elastomeric polymer,

D) 0 to 30% by weight of customary additives and processing aids,

where the percentages by weight of components A) to D) together add up to 100%.

EP 0 667 367 A2 further relates to the use of these molding compositions for production of fibers, films and moldings. The copolyamides described already have an acceptable glass transition temperature coupled with a high crystallinity and a sufficiently high melting point.

There is still a need for semiaromatic copolyamides for polyamide molding compositions having an improved profile of properties in terms of processibility thereof and the mechanical properties obtained at high temperatures.

It is an object of the present invention to provide semiaromatic copolyamides with improved properties. These are specifically to be suitable for production of polyamide molding compositions from which it is preferentially possible to produce components for the automobile industry and the electrical/electronics sector.

It has been found that, surprisingly, the use of higher amounts of at least one cyclic diamine than described in EP 0 667 367 A2 achieves copolyamides with significantly higher glass transition temperatures, combined with high crystallinity and equally high melting point. The copolyamides thus obtained are thus processible at the same temperatures, but feature better mechanical properties at high temperatures. This is especially true when the amine component of the copolyamides comprises isophoronediamine or consists of isophoronediamine.

### SUMMARY OF THE INVENTION

The invention firstly provides a semiaromatic copolyamide PA) comprising in copolymerized form:

a) 36 to 50 mol % of terephthalic acid,

b) 0 to 14 mol % of isophthalic acid,

c) 35 to 42.5 mol % of hexamethylenediamine,

d) 7.5 to 15 mol % of at least one cyclic diamine,

where components a) to d) together add up to 100 mol %.

The invention further provides polyamide molding compositions comprising a semiaromatic copolyamide as defined above and hereinafter.

The invention further provides for the use of a semiaromatic copolyamide for production of polyamide molding compositions which serve especially for production of components for high-temperature automotive applications and the electrical/electronics sector.

### DESCRIPTION OF THE INVENTION

The glass transition temperatures (Tg), melting temperatures (Tm) and heat, of fusion (AH) described in the context of this application can be determined by means of differential scanning calorimetry (DSC). The determination can be effected in a manner known per se (DIN EN ISO 11357, Parts 1 to 3). The index (2) for enthalpy of fusion Aft, glass transition temperature T_{g2} and melting temperature Tₘ₂ means that the second measurement is concerned (1st repetition), meaning that the sample of the copolyamide PA is conditioned by the performance of a first DSC analysis in which the sample is heated to melting temperature. The determination is effected under nitrogen in open crucibles at a heating rate in the region of about 20 K/min.

The condensation of the monomers of the acid component and of the diamine components forms repeat units or end groups in the form of amides derived from the respective monomers. These monomers generally account for 95 mol %, especially 99 mol %, of all the repeat units and end groups present in the copolyamide. In addition, the copolyamide may also comprise small amounts of other repeat units which may result from degradation reactions or side reactions of the monomers, for example of the diamines.

For the monomers used in accordance with the invention, the following abbreviations are used:

6=hexamethylenediamine, T=terephthalic acid, I=isophthalic acid, MXDA=m-xylylenediamine, IPDA=isophoronediamine

Preferably, the semiaromatic copolymer comprises 40 to 50 mol % of copolymerized terephthalic acid a).

Preferably, the semiaromatic copolymer comprises 0 to 10 mol % of copolymerized isophthalic acid b).

Preferably, the semiaromatic copolymer comprises 35 to 40 mol % of copolymerized hexamethylenediamine c).

Preferably, the semiaromatic copolymer comprises 10 to 15 mol % of at least one copolymerized cyclic diamine d).

The cyclic diamine d) is preferably selected from isophoronediamine (IPDA), bis(3-methyl-4-aminocyclohexyl)methane (MACM), 4,4′-(aminocyclohexyl)methane (PACM), m-xylylenediamine, p-xylylenediamine and mixtures thereof.

More preferably, the cyclic diamine d) comprises isophoronediamine or consists of isophoronediamine.

The inventive copolyamide is preferably selected from 6.T/IPDA.T and 6.T/6.I/IPDA.T/IPDA.I.

The inventive copolyamide preferably comprises terephthalic acid and isophthalic acid copolymerized in a molar ratio of 100:0 to 80:20.

The inventive copolyamide preferably comprises hexamethylenediamine and at least one cyclic diamine copolymerized in a molar ratio of 70:30 to 85:15.

In a particularly preferred embodiment, the inventive copolyamide comprises hexamethylenediamine and isophoronediamine copolymerized in a molar ratio of 75:25 to 85:15.

The inventive copolyamide preferably has a glass transition temperature T_{g2} (determined in the 2nd heating step) of at least 145° C., preferably of at least 150° C.

The inventive copolyamide preferably has a glass transition temperature T_{g2} of at least 145° C., more preferably of at least 150° C., especially preferably of at least 153° C., particularly of at least 160° C. A suitable value range is, for example, from 145 to 175° C., preferably from 150 to 175° C.

The inventive copolyamide preferably has a heat of fusion ΔH2 of at least 40 J/g. The heat of fusion ΔH2 is preferably above 50 J/g.

The inventive copolyamide preferably has an amine end group content (AEG) of 50 to 100 mol/g.

The inventive copolyamide preferably has a viscosity number of 80 to 120 ml/g. The viscosity number (Staudinger function, referred to as VN or J) is defined as VN=1/c×(η−ηₛ)/ηₛ. The viscosity number is directly related to the mean molar mass of the copolyamide and gives information about the processibility of a polymer. The viscosity number can be determined to EN ISO 307 with an Ubbelohde viscometer.

The inventive copolyamide preferably has a number-average molecular weight Mₙ within a range from 13 000 to 25 000 g/mol, more preferably from 15 000 to 20 000 g/mol.

The inventive copolyamide preferably has a weight-average molecular weight M_{w} within a range from 25 000 to 125 000.

The figures for the number-average molecular weight Mₙ and for the weight-average molecular weight M_{w} in the context of this invention are each based on a determination by means of gel permeation chromatography (GPC). For calibration, PMMA is used as a polymer standard with a low polydispersity.

The inventive copolyamide preferably has a polydispersity PD (=M_{w}/Mₙ) of not more than 6, more preferably of not more than 5, especially of not more than 3.5.

The inventive semiaromatic polyamides can in principle be prepared by customary processes known to those skilled in the art. The preparation of semiaromatic polyamides generally begins with the formation of an aqueous salt solution from at least one diamine and at least one dicarboxylic acid. The formation of the salt solution is then followed by an oligomerization in the liquid aqueous phase. For the desired increase in molecular weight, it is then necessary to remove water later in the process and to increase the reaction temperature. To increase the molecular weight further, two alternative routes are available in principle. In the first variant, the oligomer formed is converted by dewatering to the solid phase and subjected to what is called a solid state polymerization (SSP). In the second variant, water is removed in a controlled manner and the temperature is increased to convert the aqueous solution to the melt for further polycondensation. To further increase the molecular weight, a postpolymerization, for example in an extruder, may then follow if required.

Some of the possible processes are to be detailed by way of example hereinafter, the disclosure content of these documents regarding the preparation of the semiaromatic copolyamides being fully incorporated into the disclosure content of the present application.

A suitable process is described, for example, in EP 0 693 515 A1. This involves the preparation of precondensates of semiaromatic polyamides in a multistage batchwise operation comprising the following stages a) to e):

a) a salt formation phase for preparation of salt(s) from diamine(s) and dicarboxylic acid(s) and optionally partial prereaction to give low molecular weight oligoamides at temperatures between 120° C. and 220° C. and pressures of up to 23 bar,

b) optionally the transfer of the solution from stage a) into a second reaction vessel or a stirred autoclave under the conditions which exist at the end of preparation thereof,

c) the reaction phase, during which the conversion to the precondensates is promoted, through heating of the reactor contents to a given temperature and controlled adjustment of the partial steam pressure to a given value which is maintained by controlled release of steam or optionally controlled introduction of steam from a steam generator connected to the autoclave,

d) a steady-state phase which has to be maintained for at least 10 minutes, in the course of which the temperature of the reactor contents and the partial steam pressure are each set to the values envisaged for the transfer of the precondensates into the downstream process stage,

where the temperature of the reactor contents during phases c) and d) must not exceed 265° C. in the case of precondensates of semicrystalline (co)polyamides having a melting point of more than 280° C., and particular, more accurately defined boundary conditions in relation to the dependence of the minimum partial steam pressure PH2O (minimum) to be employed on the temperature of the reactor contents and the amide group concentration of the polymer have to be complied with for said semicrystalline (co)polyamides during phases c) and d), and

e) a discharge phase, during which the precondensates can be supplied to a final reaction apparatus either directly in the molten state or after passing through the solid state and optionally further process stages.

EP 0976774 A2 describes a process for preparing polyamides, comprising the following steps:

i) polycondensing a dicarboxylic acid component comprising terephthalic acid, and a diamine component having a 1,9-nonanediamine and/or 2-methyl-1,8-octanediamine content of 60 to 100 mol % in the presence of 15 to 35% by weight of water at a reaction temperature of 250 to 280° C. and a reaction pressure which satisfies the following equation:

P₀≧P≧0.7 P₀

where P₀ is the saturation vapor pressure of water at the reaction temperature, to obtain a primary polycondensate,

(ii) discharging the primary polycondensate from step i) in an atmospheric environment with the same temperature range and at the same water content as in step i),

(iii) increasing the molecular weight by subjecting the discharge from step ii) to a solid state polymerization or a melt polymerization.

EP 0 129 195 A1 describes a process for continuously preparing polyamides, in which an aqueous solution of salts of dicarboxylic acids and diamines is heated to a temperature of 250 to 300° C. in an evaporator zone under elevated pressure with simultaneous evaporation of water and formation of a prepolymer, prepolymer and vapor are separated continuously, the vapors are rectified and entrained diamines are recycled, the prepolymer is passed into a polycondensation zone and condensed under a gauge pressure of 1 to 10 bar at a temperature of 250 to 300° C., wherein the aqueous salt solution is heated under a gauge pressure of 1 to 10 bar within a residence time of not more than 60 seconds, with the proviso that the degree of conversion on exit from the evaporator zone is at least 93% and the water content of the prepolymer is not more than 7% by weight.

EP 0 129 196 A1 describes a process analogous to EP 0 129 195 A1, in which the aqueous salt solution is condensed in the first third of a tubular precondensation zone provided with internals under a gauge pressure of 1 to 10 bar up to a degree of conversion of at least 93% and the prepolymer and the vapor phase are brought into intimate contact with one another in the remaining two thirds of the precondensation zone.

WO 02/28941 describes a continuous process for hydrolytic polymerization of polyamides, comprising:

a) polymerizing an aqueous salt solution of diacids and diamines under conditions of temperature and pressure sufficient to yield a reaction mixture in multiple phases, but for a reaction time sufficient to avoid phase separation,

b) transferring heat into said reaction mixture while simultaneously reducing pressure of said reaction mixture sufficient to remove the water therefrom without solidification thereof,

c) further polymerizing said reaction mixture having had the water removed until the desired molecular weight is achieved.

U.S. Pat. No. 4,019,866 describes a process and an apparatus for continuous polyamide preparation. In the process, the polyamide-forming reactants are pumped continuously into a reaction zone designed to permit rapid heating and homogeneous mixing. The reactants are heated and mixed homogeneously within the reaction zone for a predetermined hold-up time and at an elevated temperature and elevated pressure to form a vapor and a prepolymer. The vapor formed is separated from the prepolymers and the prepolymers are withdrawn from the reaction zone. The apparatus used is configured in the manner of a column and comprises a rectifying zone and a first and second reaction zone. In the first reaction zone a polyamide-forming salt solution is partly vaporized and partly converted, and in the second reaction zone the reaction is continued at a lower pressure than in the first reaction zone. The vapor from the first reaction zone is released through the rectifying zone.

EP 0 123 377 A2 describes a condensation process which serves, inter alia, for preparation of polyamides. In this process, a salt solution or a prepolymer is expanded in a flash reactor at a relative pressure (gauge pressure) of 0 to 27.6 bar. The residence time in the flash reactor is 0.1 to 20 seconds. In a specific implementation, a prepolymerization is first effected at a temperature of 191 to 232° C. and a solvent content (water content) of less than 25% by weight. The resulting salt solution is then brought to a relative pressure of 103.4 to 206.8 bar, and only then is the temperature increased to a value above the melting temperature and the solution expanded. The polymer can be fed into a twin-screw extruder and subjected there to a polymerization at a residence time of about 45 seconds to 7 minutes.

DE 4329676 A1 describes a process for continuous polycondensation of high molecular weight, especially amorphous, semiaromatic copolyamides, wherein a precondensate is first prepared from an aqueous reaction mixture while heating and at pressure at least 15 bar, then the temperature and pressure are increased to prepare a prepolymer and ultimately the copolyamide through condensation in a vented extruder. In the course of this, the water content is reduced as early as in the precondensation stage, and at the end of the precondensation is about 5 to 40% by weight. The prepolymer is then prepared at 220 to 350° C. and a pressure of at least 20 bar. The postpolymerization is then performed in a twin-screw extruder with venting zones.

For preparation of the inventive polyamides, it is possible to use at least one catalyst. Suitable catalysts are preferably selected from inorganic and/or organic phosphorus, tin or lead compounds, and mixtures thereof.

Examples of tin compounds suitable as catalysts include tin(II) oxide, tin(II) hydroxide, tin(II) salts mono- or polybasic carboxylic acids, e.g. tin(II) dibenzoate, tin(II) di(2-ethylhexanoate), tin(II) oxalate, dibutyltin oxide, butyltin acid (C₄H₉-SnOOH), dibutyltin dilaurate, etc. Suitable lead compounds are, for example, lead(II) oxide, lead(II) hydroxide, lead(II) acetate, basic lead(II) acetate, lead(II) carbonate, etc.

Preferred catalysts are phosphorus compounds such as phosphoric acid, phosphorous acid, hypophosphorous acid, phenylphosphonic acid, phenylphosphinic acid and/or salts thereof with mono- to trivalent cations, for example Na, K, Mg, Ca, Zn or Al and/or esters thereof, for example triphenyl phosphate, triphenyl phosphite or tris(nonylphenyl) phosphite. Particularly preferred catalysts are hypophosphorous acid and salts thereof, such as sodium hypophosphite.

The catalysts are preferably used in an amount of 0.005 to 2.5 percent by weight, based on the total weight of components a) to d).

Particular preference is given to using hypophosphorous acid and/or a salt in an amount of 50 to 1000 ppm, more preferably of 100 to 500 ppm, based on the total amount of components a) to d).

For control of the molar mass, it is possible to use at least one chain transfer agent, preferably selected from monocarboxylic acids and monoamines. The chain transfer agent is preferably selected from acetic acid, propanoic acid, butyric acid, valeric acid, caproic acid, lauric acid, stearic acid, 2-ethylhexanoic acid, cyclohexanoic acid, benzoic acid, 3-(3,5-di-tert-butyl-4-hydroxyphenyl)propanoic acid, 3,5-di-tert-butyl-4-hydroxybenzoic acid, 3-(3-tert-butyl-4-hydroxy-5-methylphenyl)propanoic acid, 243,5-di-tert-butyl-4-hydroxybenzylthio)acetic acid, 3,3-bis(3-tert-butyl-4-hydroxyphenyl)butanoic acid, butylamine, pentylamine, hexylamine, 2-ethylhexylamine, n-octylamine, n-dodecylamine, n-tetradecylamine, n-hexadecylamine, stearylamine, cyclohexylamine, 3-(cyclohexylamino)propylamine, methylcyclohexylamine, dimethylcyclohexylamine, benzylamine, 2-phenylethylamine, 2,2,6,6-tetramethylpiperidin-4-amine, 1,2,2,6,6-pentamethylpiperidin-4-amine, 4-amino-2,6-di-tert-butylphenol and mixtures thereof. It is also possible to use other monofunctional compounds which can react with an amino or acid group as the transfer agent, such as anhydrides, isocyanates, acid halides or esters. The chain transfer agent can be added to the reaction mixture before or at the start of the oligomerization and/or to the prepolymer prior to the postpolymerization. The customary use amount of the chain transfer agents is within a range from 5 to 500 mmol per kg of components used for polyamide formation, preferably 10 to 200 mmol per kg of components used for polyamide formation.

In a specific embodiment, the inventive copolyamides are prepared by providing an aqueous composition composed of terephthalic acid a), isophthalic acid b), hexamethylenediamine c) and at least one cyclic diamine d) and subjecting it to salt formation. If desired, further components such as catalysts, chain transfer agents and different additives can be added to this solution. Suitable additives are described in detail hereinafter for the polyamide molding compositions. The additives which can also be added directly in the course of preparation of the inventive polyamides include, for example, antioxidants, light stabilizers, customary processing aids, nucleating agents and crystallization accelerators. These can generally be added to the inventive polyamides at any stage in the preparation. It is also possible to use fillers and reinforcers directly in the course of production of the inventive polyamides. Fillers and reinforcers are preferably added before and/or during the final postpolymerization. For example, they can be added to the inventive copolyamides in the course of postpolymerization in an extruder or kneader. In this case, it is advantageous when the extruder has suitable mixing elements, such as kneading blocks.

This composition provided for preparation of the inventive copolyamides preferably has a water content of 20 to 55% by weight, more preferably of 25 to 50% by weight, based on the total weight of the solution.

The aqueous composition can be prepared in a customary reaction apparatus, for example in a stirred tank. Preference is given to mixing the components while heating. Preferably, the aqueous composition is prepared under conditions under which there is essentially no oligomerization yet. Preferably, the temperature in the course of preparation of the aqueous composition in step a) is within a range from 80 to 170° C., more preferably from 100 to 165° C. Preference is given to preparing the aqueous composition at ambient pressure or under elevated pressure. The pressure is preferably within a range from 0.9 to 50 bar, more preferably from 1 bar to 10 bar. In a specific implementation, the aqueous composition is prepared at the autogenous pressure of the reaction mixture. The aqueous composition can be prepared in an inert gas atmosphere. Suitable inert gases are, for example, nitrogen, helium or argon. In many cases, full inertization is not required; instead, merely purging of the reaction apparatus with an inert gas prior to heating of the components is sufficient. In a suitable procedure for preparation of the aqueous composition, the diamine component is initially charged in the reaction apparatus dissolved in at least a portion of the water. Subsequently, the other components are added, preferably while stirring, and the water content is adjusted to the desired amount. The reaction mixture is heated while stirring until a clear homogeneous solution has formed. The aqueous composition thus obtained is preferably used for oligomerization essentially at the preparation temperature, i.e. without any intermediate cooling.

The oligomerization to form prepolymers and the postpolymerization to increase the molecular weight can be effected by customary processes known to those skilled in the art. Some examples of such processes have already been mentioned above.

The inventive semiaromatic copolyamides, before being processed to give polyamide molding compositions, can be subjected to a shaping operation, in which polyamide particles are obtained. Preferably, the polyamide is first shaped to one or more strands. For this purpose, it is possible to use apparatuses known to those skilled in the art, for example extruders having perforated plates, dies or die plates, for example, on the discharge side. Preferably, the semiaromatic polyamide is shaped in the free-flowing state to strands and subjected to pelletization in the form of strands of free-flowing reaction product or after cooling.

Polyamide Molding Composition

The invention further provides a polyamide molding composition comprising at least one inventive semiaromatic copolyamide.

Preference is given to a polyamide molding composition comprising:

A) 25 to 100% by weight at least one semiaromatic copolyamide, as defined above,

B) 0 to 75% by weight of at least one filler and reinforcer,

C) 0 to 50% by weight of at least one additive,

where components A) to C) together add up to 100% by weight.

The term “filler and reinforcer” (=component B) is understood in a broad sense in the context of the invention and comprises particulate fillers, fibrous substances and any intermediate forms. Particulate fillers may have a wide range of particle sizes ranging from particles in the form of dusts to large grains. Useful filler materials include organic or inorganic fillers and reinforcers. For example, it is possible to use inorganic fillers, such as kaolin, chalk, wollastonite, talc, calcium carbonate, silicates, titanium dioxide, zinc oxide, graphite, glass particles, e.g. glass beads, nanoscale fillers, such as carbon nanotubes, carbon black, nanoscale sheet silicates, nanoscale alumina (Al₂O₃), nanoscale titania (TiO₂), graphene, permanently magnetic or magnetizable metal compounds and/or alloys, sheet silicates and nanoscale silica (SiO₂). The fillers may also have been surface treated.

Examples of sheet silicates used in the inventive molding compositions include kaolins, serpentines, talc, mica, vermiculites, illites, smectites, montmorillonite, hectorite, double hydroxides or mixtures thereof. The sheet silicates may have been surface treated or may be untreated.

In addition, it is possible to use one or more fibrous substances. These are preferably selected from known inorganic reinforcing fibers, such as boron fibers, glass fibers, carbon fibers, silica fibers, ceramic fibers and basalt fibers; organic reinforcing fibers, such as Aramid fibers, polyester fibers, nylon fibers, polyethylene fibers and natural fibers, such as wood fibers, flax fibers, hemp fibers and sisal fibers.

It is especially preferable to use glass fibers, carbon fibers, Aramid fibers, boron fibers, metal fibers or potassium titanate fibers.

Specifically, chopped glass fibers are used. More particularly, component B) comprises glass fibers and/or carbon fibers, preference being given to using short fibers. These preferably have a length in the range from 2 to 50 mm and a diameter of 5 to 40 μm. Alternatively, it is possible to use continuous fibers (rovings). Suitable fibers are those having a circular and/or noncircular cross-sectional area, in which latter case the ratio of dimensions of the main cross-sectional axis to the secondary cross-sectional axis is especially >2, preferably in the range from 2 to 8 and more preferably in the range from 3 to 5.

In a specific implementation, component B) comprises what are called “flat glass fibers”. These specifically have a cross-sectional area which is oval or elliptical or elliptical and provided with indentation(s) (called “cocoon” fibers) or rectangular or virtually rectangular. Preference is given here to using glass fibers with a noncircular cross-sectional area and a ratio of dimensions of the main cross-sectional axis to the secondary cross-sectional axis of more than 2, preferably of 2 to 8, especially of 3 to 5.

For reinforcement of the inventive molding compositions, it is also possible to use mixtures of glass fibers having circular and noncircular cross sections. In a specific implementation, the proportion of flat glass fibers, as defined above, predominates, meaning that they account for more than 50% by weight of the total mass of the fibers.

If rovings of glass fibers are used as component B), these preferably have a diameter of 10 to 20 μm, preferably of 12 to 18 μm. In this case, the cross section of the glass fibers may be round, oval, elliptical, virtually rectangular or rectangular. Particular preference is given to what are called flat glass fibers having a ratio of the cross-sectional axes of 2 to 5. More particularly, E glass fibers are used. However, it is also possible to use all other glass fiber types, for example A, C, D, M, S or R glass fibers or any desired mixtures thereof, or mixtures with E glass fibers.

The inventive polyamide molding compositions can be produced by the known processes for producing long fiber-reinforced rod pellets, especially by pultrusion processes, in which the continuous fiber strand (roving) is fully saturated with the polymer melt and then cooled and cut. The long fiber-reinforced rod pellets obtained in this manner, which preferably have a pellet length of 3 to 25 mm, especially of 4 to 12 mm, can be processed further by the customary processing methods, for example injection molding or press molding, to give moldings.

The inventive polyamide molding composition comprises preferably 25 to 75% by weight, more preferably 33 to 60% by weight, of at least one filler and reinforcer B), based on the total weight of the polyamide molding composition.

Suitable additives C) are heat stabilizers, flame retardants, light stabilizers (UV stabilizers, UV absorbers or UV blockers), lubricants, dyes, nucleating agents, metallic pigments, metal flakes, metal-coated particles, antistats, conductivity additives, demolding agents, optical brighteners, defoamers, etc.

As component C), the inventive molding compositions comprise preferably 0.01 to 3% by weight, more preferably 0.02 to 2% by weight and especially 0.1 to 1.5% by weight of at least one heat stabilizer.

The heat stabilizers are preferably selected from copper compounds, secondary aromatic amines, sterically hindered phenols, phosphites, phosphonites and mixtures thereof.

If a copper compound is used, the amount of copper is preferably 0.003 to 0.5%, especially 0.005 to 0.3% and more preferably 0.01 to 0.2% by weight, based on the sum of components A) to C).

If stabilizers based on secondary aromatic amines are used, the amount of these stabilizers is preferably 0.2 to 2% by weight, more preferably from 0.2 to 1.5% by weight, based on the sum of components A) to C).

If stabilizers based on sterically hindered phenols are used, the amount of these stabilizers is preferably 0.1 to 1.5% by weight, more preferably from 0.2 to 1% by weight, based on the sum of components A) to C).

If stabilizers based on phosphites and/or phosphonites are used, the amount of these stabilizers is preferably 0.1 to 1.5% by weight, more preferably from 0.2 to 1% by weight, based on the sum of components A) to C).

Suitable compounds C) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, CuI, CuCN and Cu₂O, and to the divalent copper compounds CuCl₂, CuSO₄, CuO, copper(II) acetate or copper(II) stearate.

The copper compounds are commercially available, or the preparation thereof is known to those skilled in the art. The copper compound can be used as such or in the form of concentrates. A concentrate is understood to mean a polymer, preferably of the same chemical nature as component A), which comprises the copper salt in high concentration. The use of concentrates is a standard method and is employed particularly frequently when very small amounts of a feedstock have to be metered in. Advantageously, the copper compounds are used in combination with further metal halides, especially alkali metal halides, such as NaI, KI, NaBr, KBr, in which case the molar ratio of metal halide to copper halide is 0.5 to 20, preferably 1 to 10 and more preferably 3 to 7.

Particularly preferred examples of stabilizers which are based on secondary aromatic amines and are usable in accordance with the invention are adducts of phenylenediamine with acetone (Naugard A), adducts of phenylenediamine with linolenic acid, Naugard® 445, N,N′-dinaphthyl-p-phenylenediamine, N-phenyl-N′-cyclohexyl-p-phenylenediamine or mixtures of two or more thereof.

Particularly preferred examples of stabilizers which are based on sterically hindered phenols and are usable in accordance with the invention are N,N′-hexamethylenebis-3-(3,5-di-tert-butyl-4-hydroxyphenyl)propionamide, bis(3,3-bis(4′-hydroxy-3′-tert-butylphenyl)butanoic acid) glycol ester, 2,1′-thioethyl bis(3-(3,5-di-tert-butyl-4-hydroxyphenyl)propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenz[d,g]-1,3,2-dioxaphosphocin, 6-fluoro-2,4,8,10-tetra-tert-butyl-12-methyldibenz[d,g]-1,3,2-dioxaphosphocin, bis(2,4-di-tert-butyl-6-methylphenyl)methyl phosphite and bis(2,4-di-tert-butyl-6-methylphenyl) ethyl phosphite. More particularly, preference is given to tris[2-tert-butyl-4-thio(2′-methyl-4′-hydroxy-5′-tert-butyl)phenyl-5-methyl]phenyl phosphite and tris(2,4-di-tert-butylphenyl) phosphite (Hostanox® PAR24: commercial product from BASF SE).

A preferred embodiment of the heat stabilizer consists in the combination of organic heat stabilizers (especially Hostanox PAR 24 and Irganox 1010), a bisphenol A-based epoxide (especially Epikote 1001) and copper stabilization based on CuI and KI. An example of a commercially available stabilizer mixture consisting of organic stabilizers and epoxides is Irgatec NC66 from BASF SE. More particularly, preference is given to heat stabilization exclusively based on CuI and KI. Aside from the use of copper or copper compounds, the use of further transition metal compounds, especially metal salts or metal oxides of group VB, VIB, VIIB or VIIIB of the Periodic Table, is ruled out. In addition, it is preferable not to add any transition metals of group VB, VIB, VIIB or VIIIB of the Periodic Table, for example iron powder or steel powder, to the inventive molding composition.

The inventive molding compositions comprise preferably 0 to 30% by weight, more preferably 0 to 20% by weight, based on the total weight of components A) to C), of at least one flame retardant as additive C). When the inventive molding compositions comprise at least one flame retardant, they preferably do so in an amount of 0.01 to 30% by weight, more preferably of 0.1 to 20% by weight, based on the total weight of components A) to C). Useful flame retardants C) include halogenated and halogen-free flame retardants and synergists thereof (see also Gächter/Müller, 3rd edition 1989 Hanser Verlag, chapter 11). Preferred halogen-free flame retardants are red phosphorus, phosphinic or diphosphinic salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art, and also polymeric melamine phosphate (CAS No.: 56386-64-2 or 218768-84-4, and also EP 1095030), ammonium polyphosphate, trishydroxyethyl isocyanurate (optionally also ammonium polyphosphate in a mixture with trishydroxyethyl isocyanurate) (EP584567). Further N-containing or P-containing flame retardants, or PN condensates suitable as flame retardants, can be found in DE 10 2004 049 342, as can the synergists likewise customary for this purpose, such as oxides or borates. Suitable halogenated flame retardants are, for example, oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, Dechlorane, which are usually used with antimony oxides as synergists (for details and further flame retardants see DE-A-10 2004 050 025).

The antistats used in the inventive molding compositions may, for example, be carbon black and/or carbon nanotubes. The use of carbon black may also serve to improve the black color of the molding composition. However, the molding composition may also be free of metallic pigments.

Molding

The present invention further relates to moldings which are produced using the inventive copolyamides or polyamide molding compositions.

The inventive semiaromatic polyamides are advantageously suitable for use for production of moldings for electrical and electronic components and for high-temperature automotive applications.

A specific embodiment is moldings in the form of or as part of a component for the automotive sector, especially selected from cylinder head covers, engine hoods, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, heating elements, securing parts.

A further specific embodiment is moldings as or as part of an electrical or electronic passive or active component of a printed circuit board, of part of a printed circuit board, of a housing constituent, of a film, or of a wire, more particularly in the form of or as part of a switch, of a plug, of a bushing, of a distributor, of a relay, of a resistor, of a capacitor, of a winding or of a winding body, of a lamp, of a diode, of an LED, of a transistor, of a connector, of a regulator, of an integrated circuit (IC), of a processor, of a controller, of a memory element and/or of a sensor.

The inventive semiaromatic polyamides are additionally specifically suitable for use in soldering operations under lead-free conditions (lead free soldering), for production of plug connectors, microswitches, microbuttons and semiconductor components, especially reflector housings of light-emitting diodes (LEDs).

A specific embodiment is that of moldings as securing elements for electrical or electronic components, such as spacers, bolts, fillets, push-in guides, screws and nuts.

Especially preferred is a molding in the form of or as part of a socket, of a plug connector, of a plug or of a bushing. The molding preferably includes functional elements which require mechanical toughness. Examples of such functional elements are film hinges, snap-in hooks and spring tongues.

Possible uses in automobile interiors are for dashboards, steering-column switches, seat components, headrests, center consoles, gearbox components and door modules, and possible uses in automobile exteriors are for door handles, exterior mirror components, windshield wiper components, windshield wiper protective housings, grilles, roof rails, sunroof frames, engine covers, cylinder head covers, intake pipes, windshield wipers, and exterior bodywork parts.

Possible uses of polyamides with improved flow for the kitchen and household sector are the production of components for kitchen machines, for example fryers, irons, knobs, and also applications in the garden and leisure sector, for example components for irrigation systems or garden equipment and door handles.

The examples which follow serve to illustrate the invention, but without restricting it in any way.

### EXAMPLES

The polyamides are prepared by condensation in the melt in a stirred pressure autoclave. For this purpose, the respective diamines and dicarboxylic acids are weighed in, and then 0.03% by weight of sodium hypophosphite is added as a catalyst. The water content was 15% by weight. After the autoclave has been purged several times with nitrogen, the external temperature is set to 345° C. After the pressure within the autoclave has reached 40 bar, it is decompressed to ambient pressure within 28 min. The polymer thus obtained is postcondensed under a constant nitrogen stream for 15 min and then released through the outlet valve as a strand and pelletized.

The glass transition temperatures (Tg₂), melting temperatures (Tm₂) and heats of fusion (ΔH₂) in table 1 were determined by means of differential scanning calorimetry (DSC). The DSC analysis on one and the same sample is appropriately repeated once or twice, in order to ensure a defined thermal history of the respective polyamide. In general, the values for the second measurement are reported. This is indicated by the index “2” in the measurements (Tg₂), (Tm₂), (ΔH₂). Each measurement was effected with a heating and cooling rate of 20 K/min.

TABLE 1

| | Composition | Tg₂ | Tm₂ | ΔH |
|---|---|---|---|---|
| Example No. | Polyamide | [° C.] | [° C.] | [J/g] |
| Comparative 1 | 6.T/6.I/IPDA.T/IPDA.I | 135.0 | 307.0 | 51 |
| | (T:I = 70:30) | | | |
| | (6:IPDA = 97.5:2.5) | | | |
| Comparative 2 | 6.T/6.I/IPDA.T/IPDA.I | 143.0 | 305.0 | 30 |
| | (T:I = 70:30) | | | |
| | (6:IPDA = 95:5) | | | |
| Comparative 3 | 6.T/6.I/IPDA.T/IPDA.I | 141.0 | 305.0 | 57 |
| | (T:I = 76:24) | | | |
| | (6:IPDA = 90:10) | | | |
| 1 | 6.T/6.I/IPDA.T/IPDA.I | 154.0 | 318.0 | 44 |
| | (T:I = 82:18) | | | |
| | (6:IPDA = 85:15) | | | |
| 2 | 6.T/6.I/IPDA.T/IPDA.I | 162.0 | 310.0 | 48 |
| | (T:I = 85:15) | | | |
| | (6:IPDA = 80:20) | | | |
| 3 | 6.T/6.I/IPDA.T/IPDA.I | 161.0 | 313.0 | 49 |
| | (T:I = 88:12) | | | |
| | (6:IPDA = 75:25) | | | |
| 4 | 6.T/IPDA.T | 166.0 | 316.0 | 44 |
| | (6:IPDA = 70:30) | | | |
| 5 | 6.T/6.I/PACM.T/PACM.I | 149.0 | 313.0 | 42.0 |
| | (T:I = 82:18) | | | |
| | (6:PACM = 85:15) | | | |
| 6 | 6.T/6.I/MACM.T/MACM.I | 149.0 | 319.0 | 48.0 |
| | (T:I = 82:18) | | | |
| | (6:MACM = 85:55) | | | |

1. A semiaromatic copolyamide comprising, in copolymerized form:
a) 36 to 50 mol % of terephthalic acid,
b) 0 to 14 mol % of isophthalic acid,
c) 35 to 42.5 mol % of hexamethylenediamine,
d) 7.5 to 15 mol % of at least one cyclic diamine, where the cyclic diamine d) comprises isophoronediamine
where components a) to d) together add up to 100 mol %.

2. The copolyamide according to claim 1, which comprises terephthalic acid and isophthalic acid copolymerized in a molar ratio of 100:0 to 80:20.

3. The copolyamide according to claim 1, which comprises hexamethylenediamine and at least one cyclic diamine copolymerized in a molar ratio of 75:25 to 85:15.

4. The copolyamide according to claim 1, which comprises hexamethylenediamine and isophoronediamine copolymerized in a molar ratio of 75:25 to 85:15.

5. The copolyamide according to claim 1, which has a glass transition temperature Tg₂ of at least 150° C.

6. The copolyamide according to claim 1, which has a heat of fusion ΔH₂ of at least 40 J/g.

7. A polyamide molding composition comprising at least one copolyamide as defined in claim 1.

8. The polyamide molding composition according to claim 7, comprising:
A) 25 to 100% by weight of at least one copolyamide as defined in claim 1,
B) 0 to 75% by weight of at least one filler and reinforcer,
C) 0 to 50% by weight of at least one additive,
where components A) to C) together add up to 100% by weight.

9. A molding produced from a polyamide molding composition according to claims 7.

10. The molding according to claim 9, in the form of or as part of a component for the automotive sector.

11. The molding according to claim 9, in the form of or as part of an electrical or electronic component.

12. A method for producing electrical and electronic components and for high-temperature automotive applications comprising the use of a semiaromatic copolyamide as defined in claim 1.

13. The method of claim 12 in soldering operations under lead-free conditions, or for production of plug connectors, microswitches, microbuttons and semiconductor components.

14. The copolyamide of claim 1 when the cyclic diamine d) consists of isophorone diamine.

15. The molding according to claim 10, in the form of or as part of a component for cylinder head covers, engine hoods, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, heating elements, and securing parts.

16. The molding according to claim 11, in the form of printed circuit boards and parts thereof, housing constituents, films, wires, switches, distributors, relays, resistors, capacitors, windings, lamps, diodes, LEDs, transistors, connectors, regulators, memory chips, and sensors.

17. The method according to claim 13 for production of reflector housings of light-emitting diodes.
